(19) United States
(12) Patent Application Publication
(10) Pub. No.: US 2019/0327942 A1
(43) Pub. Date: Oct. 31, 2019

(54) BIRD FEEDER WITH HEIGHT ADJUSTABLE PERCH AND BLOCKING ROOF

(71) Applicant: TZU YING CHI, Hui Zhou City (CN)

(72) Inventor: TZU YING CHI, Hui Zhou City (CN)

(21) Appl. No.: 15/962,890

(22) Filed: Apr. 25, 2018

(51) Int. Cl. A01K 39/01

(52) U.S. Cl. CPC A01K 39/0113

(57) ABSTRACT

A bird feeder is provided with a containing structure including an internal space and at least one feeding opening on an outer surface of the containing structure and communicating with the internal space; a perch including a central bossed hole with the containing structure disposed through, and a channel disposed through a surface of the bossed hole wherein the perch is disposed under the feeding opening and configured to slidably, longitudinally move on the containing structure; at least one positioning device disposed through the channel to urge against the containing structure for fastening the perch and the containing structure together; and a blocking roof releasably disposed on the containing structure and above the feeding opening. A height difference between the blocking roof and the perch is adjustable.

### BACKGROUND OF THE INVENTION

### 1. Technical Field

The technical field relates to bird feeders, and more particularly relates to a bird feeder having both a height adjustable perch and a height adjustable blocking roof.

### 2. Description of Related Art

Conventionally, bird feeders are placed outdoors. A bird feeder comprises a cylindrical container filled with bird food (i.e., feed), a plurality of feeding openings on the container, and a plurality of perches each disposed under the feeding opening. A bird may stand on the perch for accessing the feed through the feeding opening.

It is understood that animals such as squirrels may access the feed because the bird feeder is placed outdoors. This, however, may compromise the purpose of feeding birds.

There is a type of bird feeder having a blocking roof mounted above a containing structure with a feeding opening disposed thereunder and a perch disposed further thereunder. Small birds are allowed to stand on the perch and under the blocking roof to access the food in the containing structure via the feeding opening. However, relatively large birds are not allowed to stand on the perch for accessing food due to a small height difference between the blocking roof and the perch.

Thus, the need for improvement still exists.

### SUMMARY OF THE INVENTION

The disclosure is directed to a bird feeder for eliminating drawbacks associated with the conventional art.

It is therefore one object of the invention to provide a bird feeder comprising a containing structure including an internal space and at least one feeding opening on an outer surface of the containing structure and communicating with the internal space; a perch including a central bossed hole with the containing structure disposed through, and a channel disposed through a surface of the bossed hole wherein the perch is disposed under the feeding opening and configured to slidably, longitudinally move on the containing structure; at least one first positioning device disposed through the channel to urge against the containing structure for fastening the perch and the containing structure together; and a blocking roof releasably disposed on the containing structure and above the feeding opening.

One of the exemplary embodiments, the containing structure further comprises at least one groove longitudinally formed on an outer surface thereof, and wherein the perch further comprises at least one protrusion on an inner surface of the bossed hole, the protrusion being configured to complimentarily, slidably dispose in the groove.

One of the exemplary embodiments, the channel of the perch extends from an outer surface of the perch to terminate at the bossed hole, and the first positioning device is configured to urge against the groove of the containing structure.

One of the exemplary embodiments, the first positioning device includes an urging member and a spring member, and wherein the urging member is in an inner end of the channel and projects into the bossed hole, the spring member is in the channel and has one end urging against the urging member and the other end disposed at an outer end of the channel, and the spring member pushes the urging member to urge against the groove of the containing structure.

One of the exemplary embodiments, the channel of the perch is disposed from an outer surface of the perch to the surface of the bossed hole, and the first positioning device further comprises a plug in the channel and at the outer surface of the perch, the plug being urged by the spring member.

One of the exemplary embodiments, there is further provided a second positioning device, and wherein the blocking roof includes a central through hole put on the containing structure and configured to slidably, longitudinally move on the containing structure, and a channel disposed through a surface of the through hole with the second positioning device disposed therein, the second positioning device being configured to urge against the containing structure for fastening the blocking roof and the containing structure together.

One of the exemplary embodiments, the second positioning device includes an urging element and a spring element, and wherein the urging element is in an inner end of the channel and projects into the through hole, the spring element is in the channel and has one end urging against the urging element and the other end disposed at an outer end of the channel, and the spring element pushes the urging element to urge against the groove of the containing structure.

One of the exemplary embodiments, the channel of the blocking roof is disposed from an outer surface of the blocking roof to the surface of the through hole, and the second positioning device further comprises a plug element in the channel and at the outer surface of the perch, the plug element being urged by the spring element.

One of the exemplary embodiments, the containing structure further comprises at least one groove longitudinally formed on an outer surface thereof, and wherein the blocking roof further comprises at least one projection on an inner surface of the through hole, the projection being configured to complimentarily, slidably dispose in the groove.

One of the exemplary embodiments, the channel of the blocking roof extends from an outer surface of the blocking roof to terminate at the through hole, and the second positioning device is configured to urge against the groove of the containing structure.

It is another object of the invention to provide a bird feeder comprising a containing structure including an internal space and at least one feeding opening on an outer surface of the containing structure and communicating with the internal space; a perch with the containing structure disposed through and disposed under the feeding opening; a blocking roof above the feeding opening and including a central through hole put on the containing structure and configured to slidably, longitudinally move on the containing structure, and a channel disposed through a surface of the through hole; and at least one positioning device disposed through the channel to urge against the containing structure for fastening the blocking roof and the containing structure together.

The invention has the following advantages and benefits in comparison with the conventional art:

The perch and/or the blocking roof may slide relative to the containing structure in order to adjust the height difference between the perch and the blocking roof. Small birds may stand on the perch and larger birds and animals are prevented from perching if the height difference between the perch and the blocking roof is short. To the contrary, larger birds can stand on the perch if the height difference between the perch and the blocking roof is sufficiently long. Further, squirrels are prevented from accessing the feed.

The above and other objects, features and advantages of the invention will become apparent from the following detailed description taken with the accompanying drawings.

### BRIEF DESCRIPTION OF THE DRAWINGS

FIG. 1 is a perspective view of a bird feeder according to a first preferred embodiment of the invention;

FIG. 2 is an exploded perspective view of the bird feeder;

FIG. 3 is a side elevation of the bird feeder;

FIG. 4 is a longitudinal sectional view of the bird feeder;

FIG. 5 is a view similar to FIG. 4

FIG. 6 is a perspective view of a bird feeder according to a second preferred embodiment of the invention;

FIG. 7 is an exploded perspective view of the bird feeder of FIG. 6; and

FIG. 8 is a longitudinal sectional view of the bird feeder of FIG. 6.

### DETAILED DESCRIPTION OF THE INVENTION

Embodiments of the invention will now be described, by way of example only, with reference to the accompanying drawings.

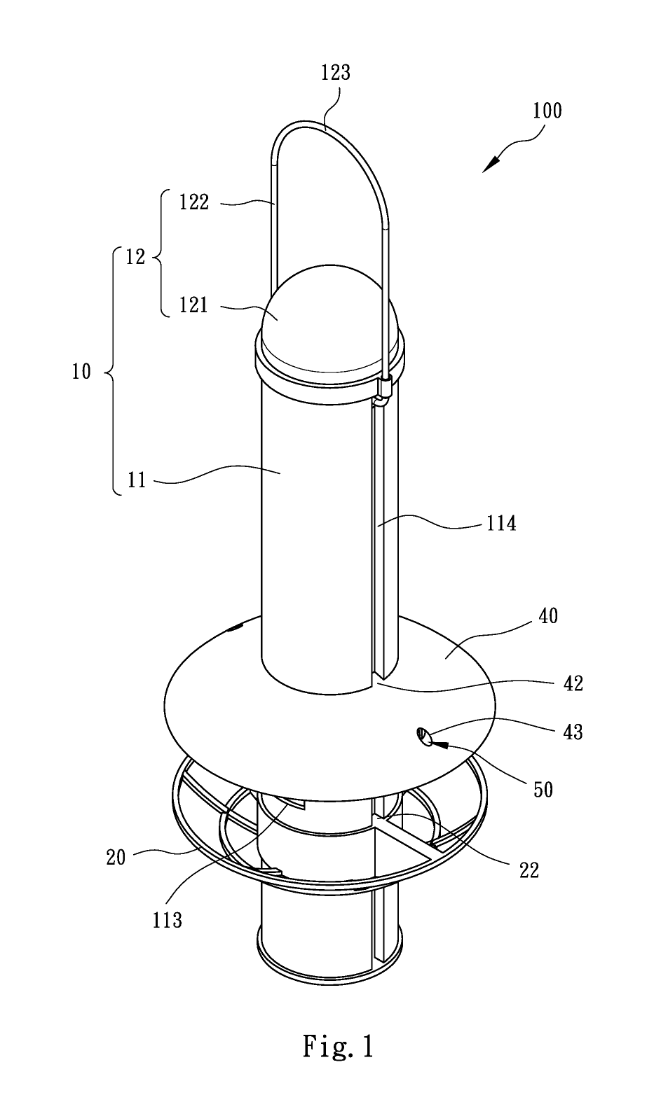

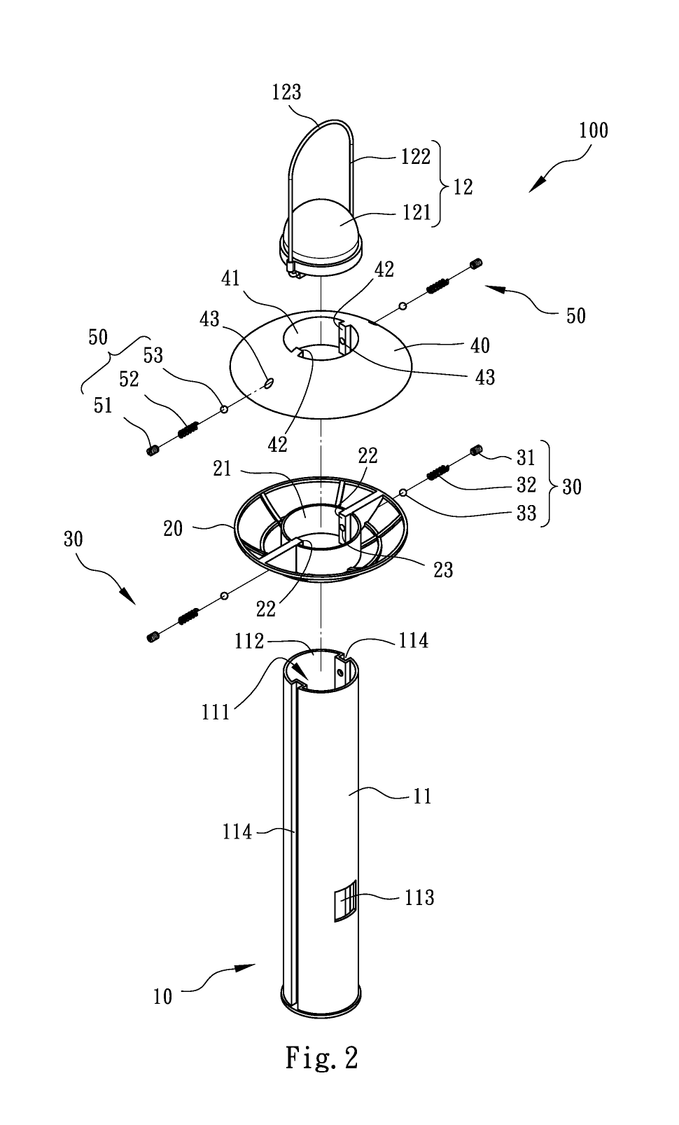

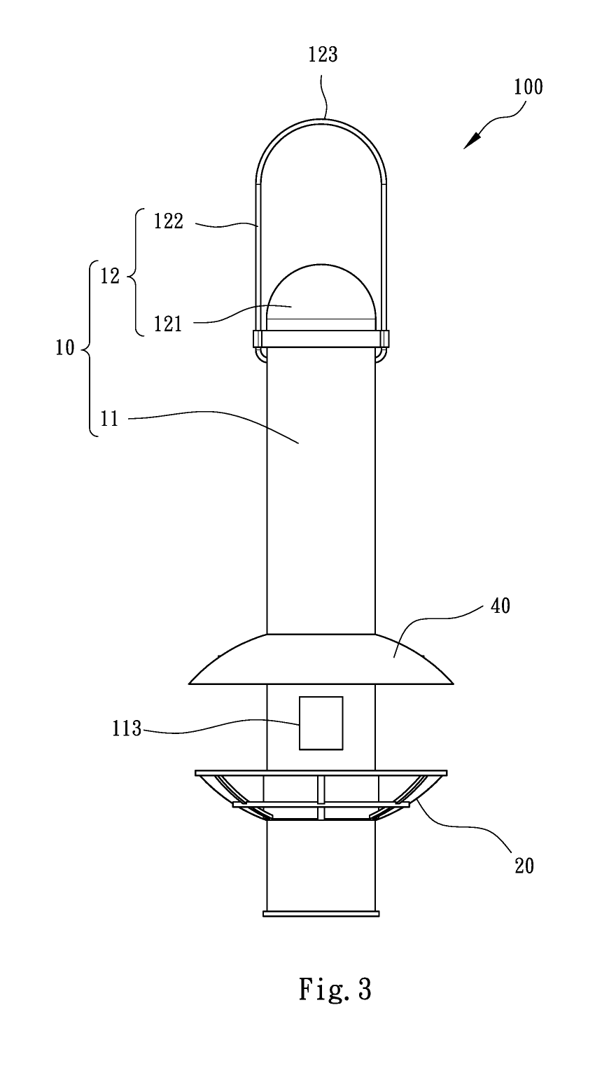

Referring to FIGS. 1 to 5, a bird feeder 100 in accordance with a first preferred embodiment of the invention comprises a containing structure 10, a perch 20, two first positioning devices 30, a blocking roof 40 and two second positioning devices 50.

As shown in FIGS. 1 to 4 specifically, the containing structure 10 comprises a cylindrical container 11 including an internal space 111, a top opening 112 for allowing feed to fill into the space 111, at least one feeding opening 113 provided on a cylindrical surface of the container 11 and communicating with the space 111, and two opposite grooves 114 each extending downward from a top edge of the top opening 112 or a bottom of the container 11; and a covering structure 12 including a dome-shaped cover 121 releasably fastened on the top opening 112, and an inverted U-shaped handle 122 having two ends hingedly secured to the cover 121, the handle 122 having an intermediate, arc-shaped hanging member 123.

As shown in FIGS. 1 to 4 specifically, the perch 20 is shaped as a concave dish and includes a central bossed hole 21, two opposite protrusions 22 each formed on an inner surface of the bossed hole 21, and two channels 23 each disposed from an outer surface of the perch 20 through the protrusion 22 to terminate at the inner surface of the bossed hole 21. The bossed hole 21 is put on the container 11 under the feeding opening 113 by sliding the protrusions 22 downward along the mating grooves 114. A separation of the container 11 and the perch 20 is made possible by sliding the protrusions 22 upward along the grooves 114.

As shown in FIGS. 1 to 4 specifically, the first positioning device 30 includes an urging member (e.g., a steel ball) 33 in an inner end of the channel 23 and projecting into the bossed hole 21, a torsion spring 32 in the channel 23 and having one end engaging the urging member 33, and a plug (e.g., a threaded plug) 31 threadedly fastened in an outer end of the channel 23 (i.e., on the outer surface of the perch 20) and engaging the other end of the torsion spring 32. In an assembled state, the plug 31 is driven to urge against the torsion spring 32 which in turn pushes the urging member 33 to urge against the groove 114. Thus, the containing structure 10 and the perch 20 are fastened together.

As shown in FIGS. 1 to 4 specifically, the blocking roof 40 has a smooth convex top surface for preventing small animals (e.g., squirrels) from perching thereon, a flat bottom surface, and a circular edge. The blocking roof 40 includes a central through hole 41, two opposite, longitudinal sliding projections 42 formed on a surface of the through hole 41, and two channels 43 each disposed from an outer surface of the blocking roof 40 to the surface of the through hole 41. The through hole 41 is put on the container 11 above the feeding opening 113 by sliding the sliding projections 42 downward along the mating grooves 114. A separation of the container 11 and the blocking roof 40 is made possible by sliding the sliding projections 42 upward along the mating grooves 114.

As shown in FIGS. 1 to 4 specifically, the second positioning device 50 includes an urging member (e.g., a steel ball) 53 in an inner end of the channel 43 and projecting into the through hole 41, a torsion spring 52 in the channel 43 and having one end engaging the urging member 53, and a plug (e.g., a threaded plug) 51 threadedly fastened in an outer end of the channel 43 (i.e., on the outer surface of the blocking roof 40) and engaging the other end of the torsion spring 52. In an assembled state, the plug 51 is driven to urge against the torsion spring 52 which in turn pushes the urging member 53 to urge against the groove 114. Thus, the containing structure 10 and the blocking roof 40 are fastened together.

Thus, components and its assembly of the bird feeder 100 in accordance with the first preferred embodiment of the invention have been described and a use thereof is described in detail below.

First, in using the bird feeder 100 of the invention, a user has to detach the covering structure 12 from the container 11, put feed (e.g., bird feed) into the space 111 through the top opening 112, and assemble the covering structure 12 and the container 11.

Next, the user may place the container 11 on the ground or put the hanging member 123 of the handle 12 on a place high above the ground (e.g., tree branch) so that birds may stand on the perch 20 to access the feed in the space 111 via the feeding opening 113.

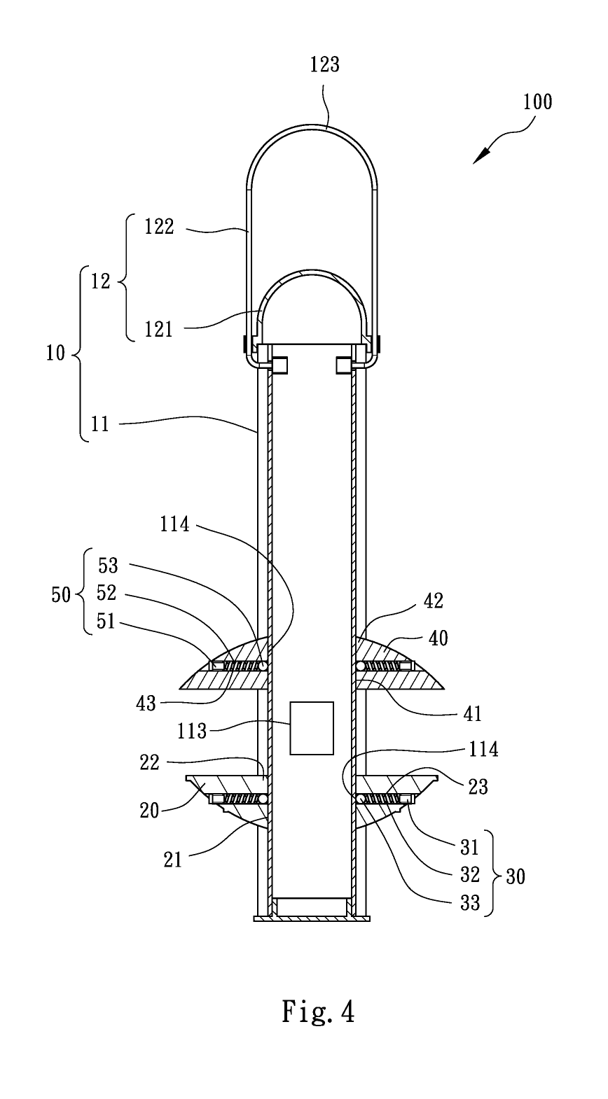

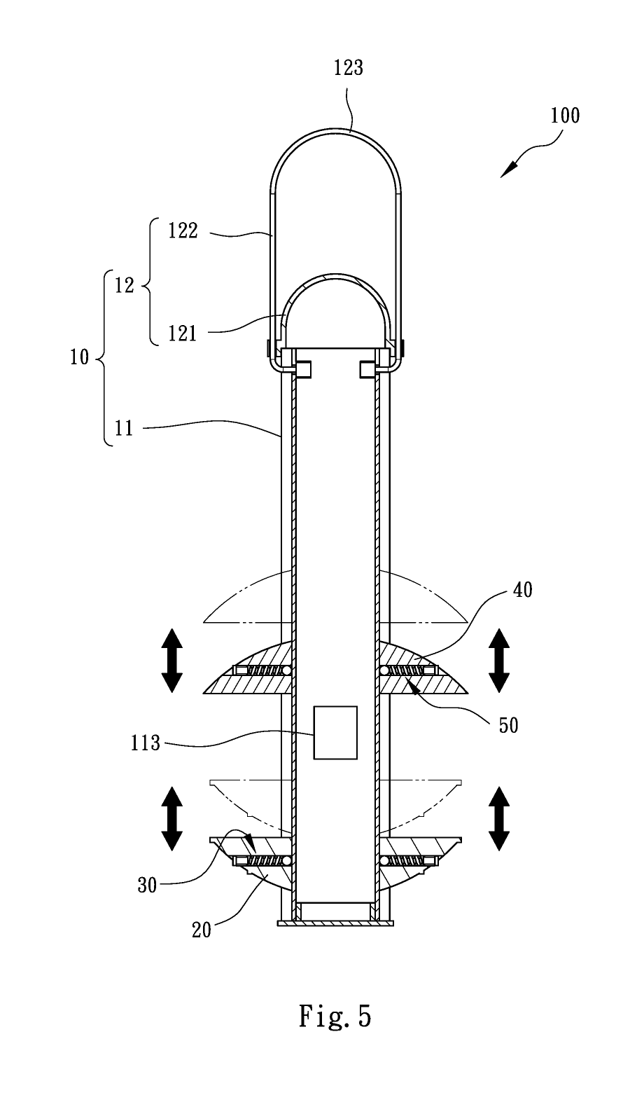

As shown in FIGS. 4 and 5 specifically, elastic force of the torsion spring 32 urges the urging member 33 against a surface of the groove 114 to fasten the perch 20 and the containing structure 10 together. For adjusting a position of the perch 20 on the container 11 (or a height difference between the perch 20 and the blocking roof 40), a user may use hand to press the perch 20 and move same either downward or upward relative to the container 11 of the containing structure 10 due to the elasticity of the torsion springs 32. After a desired position is reached, the user may release the perch 20 to fasten the perch 20 and the containing structure 10 together due to the expansion of the torsion springs 32.

Likewise, for adjusting a height difference between the perch 20 and the blocking roof 40, a user may use hand to press the blocking roof 40 and move same either downward or upward relative to the container 11 of the containing structure 10 due to the elasticity of the torsion springs 52. After a desired position is reached, the user may release the blocking roof 40 to fasten the blocking roof 40 and the containing structure 10 together due to the expansion of the torsion springs 52.

It is envisaged by the invention that the perch 20 and/or the blocking roof 40 may slide relative to the containing structure 10 in order to adjust the height difference between the perch 20 and the blocking roof 40. Small birds may stand on the perch 20 and larger birds and animals are prevented from perching if the height difference between the perch 20 and the blocking roof 40 is short. To the contrary, larger birds can stand on the perch 20 if the height difference between the perch 20 and the blocking roof 40 is sufficiently long. Thus, a user may adjust the bird feeder 10 in a desired manner.

The hanging member 13 is shaped as an arc in the first embodiment. In other embodiments, the hanging member 13 may be shaped as a hook depending upon applications.

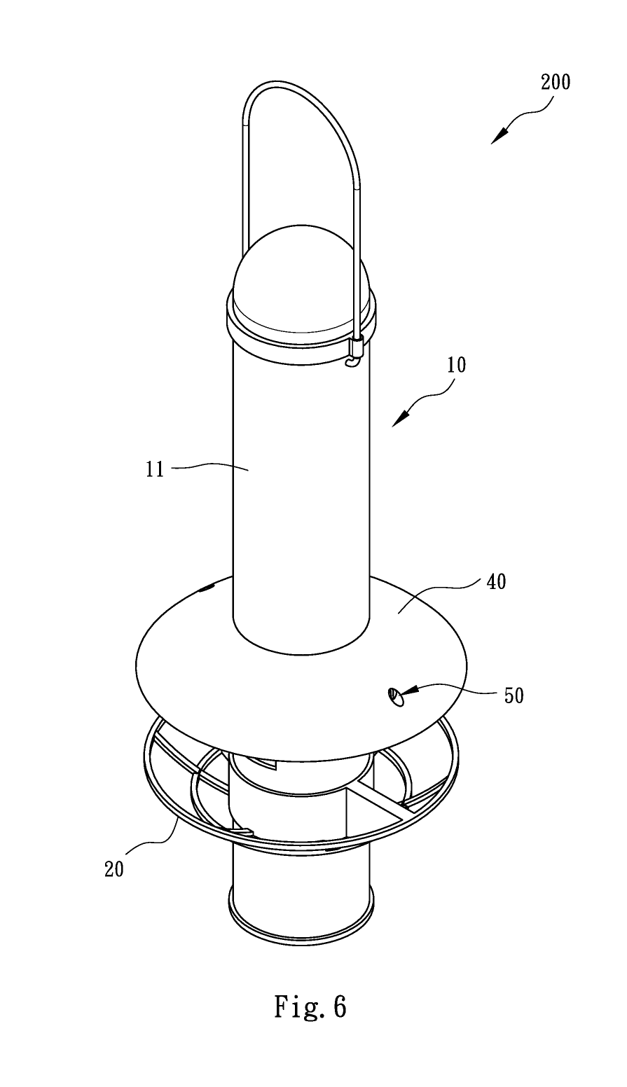

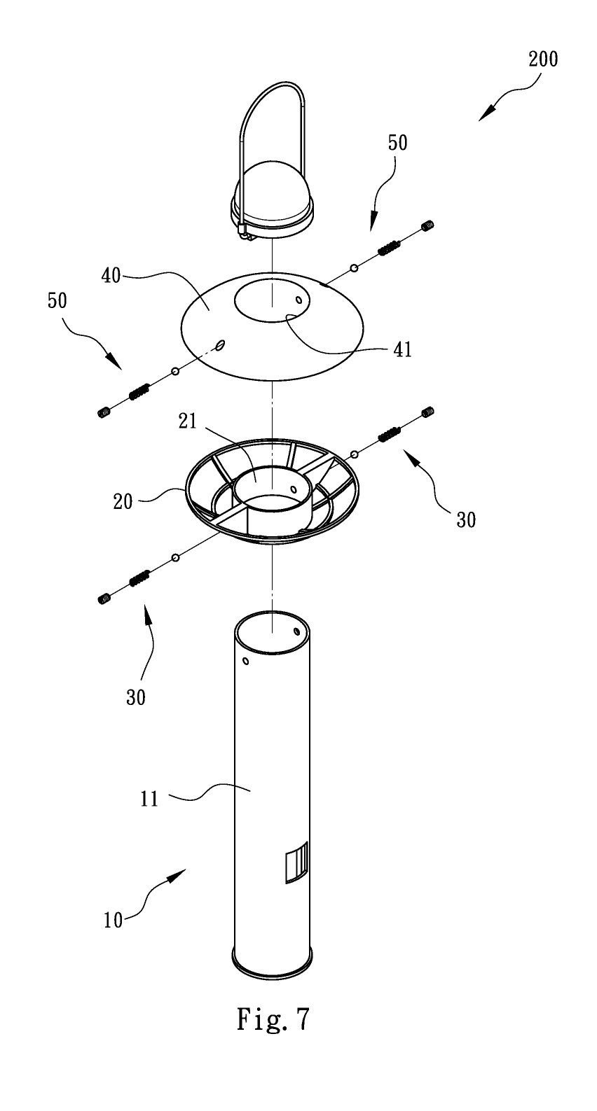

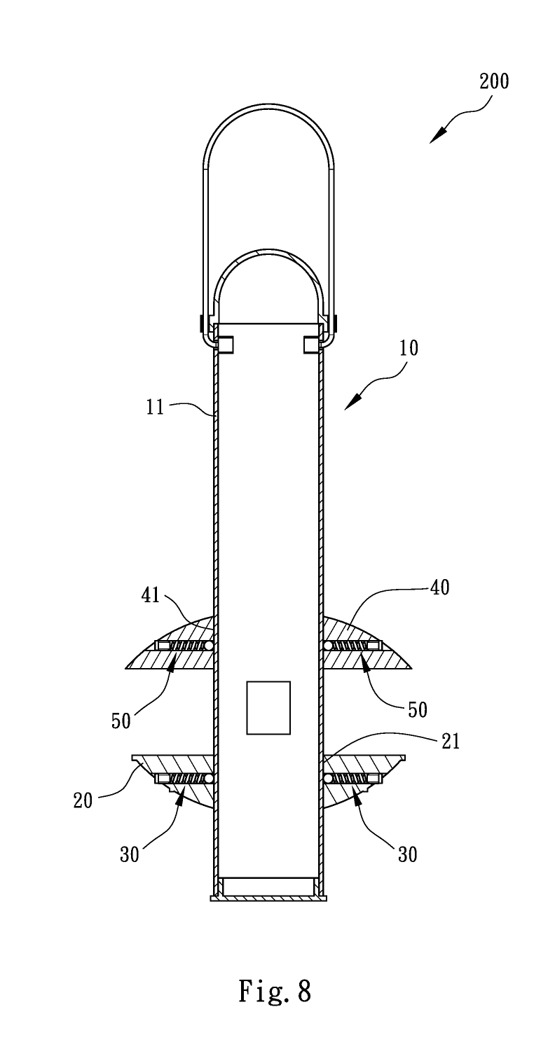

Referring to FIGS. 6 to 8, a bird feeder 200 in accordance with a second preferred embodiment of the invention. The bird feeder 200 comprises a containing structure 10, a perch 20, two first positioning devices 30, a blocking roof 40 and two second positioning devices 50. Differences between the bird feeder 200 of the second embodiment and the bird feeder 100 of the first embodiments are described in detail below.

In the second embodiment, no grooves are provided on the surface of the container 11 of the containing structure 10, no sliding projections are provided on the surface of the through hole 41 of the blocking roof 40, and the protrusions do not have a portion projecting into the bossed hole 21 of the perch 20.

Therefore, an adjustment of a position of the perch 20 (or the blocking roof 40) on the container 11 or a height difference between the perch 20 and the blocking roof 40 can be made without the mating, sliding engagement of projections (or projecting portions) and grooves. This has the advantages of saving the manufacturing cost, decreasing the assembly steps, making mass production possible, lowering the price, and being more competitive in the market.

While the invention has been described in terms of preferred embodiments, those skilled in the art will recognize that the invention can be practiced with modifications within the spirit and scope of the appended claims.

What is claimed is:

1. A bird feeder comprising:
a containing structure including an internal space and at least one feeding opening on an outer surface of the containing structure and communicating with the internal space;
a perch including a central bossed hole with the containing structure disposed through, and a channel disposed through a surface of the bossed hole wherein the perch is disposed under the feeding opening and configured to slidably, longitudinally move on the containing structure;
at least one first positioning device disposed through the channel to urge against the containing structure for fastening the perch and the containing structure together; and
a blocking roof releasably disposed on the containing structure and above the feeding opening.

2. The bird feeder as claimed in claim 1, wherein the containing structure further comprises at least one groove longitudinally formed on an outer surface thereof, and wherein the perch further comprises at least one protrusion on an inner surface of the bossed hole, the protrusion being configured to complimentarily, slidably dispose in the groove.

3. The bird feeder as claimed in claim 2, wherein the channel of the perch extends from an outer surface of the perch to terminate at the bossed hole, and the first positioning device is configured to urge against the groove of the containing structure.

4. The bird feeder as claimed in claim 1, wherein the first positioning device includes an urging member and a spring member, and wherein the urging member is in an inner end of the channel and projects into the bossed hole, the spring member is in the channel and has one end urging against the urging member and the other end disposed at an outer end of the channel, and the spring member pushes the urging member to urge against the groove of the containing structure.

5. The bird feeder as claimed in claim 4, wherein the channel of the perch is disposed from an outer surface of the perch to the surface of the bossed hole, and the first positioning device further comprises a plug in the channel and at the outer surface of the perch, the plug being urged by the spring member.

6. The bird feeder as claimed in claim 4, further comprising a second positioning device, and wherein the blocking roof includes a central through hole put on the containing structure and configured to slidably, longitudinally move on the containing structure, and a channel disposed through a surface of the through hole with the second positioning device disposed therein, the second positioning device being configured to urge against the containing structure for fastening the blocking roof and the containing structure together.

7. The bird feeder as claimed in claim 6, wherein the second positioning device includes an urging element and a spring element, and wherein the urging element is in an inner end of the channel and projects into the through hole, the spring element is in the channel and has one end urging against the urging element and the other end disposed at an outer end of the channel, and the spring element pushes the urging element to urge against the groove of the containing structure.

8. The bird feeder as claimed in claim 7, wherein the channel of the blocking roof is disposed from an outer surface of the blocking roof to the surface of the through hole, and the second positioning device further comprises a plug element in the channel and at the outer surface of the perch, the plug element being urged by the spring element.

9. The bird feeder as claimed in claim 6, wherein the containing structure further comprises at least one groove longitudinally formed on an outer surface thereof, and wherein the blocking roof further comprises at least one projection on an inner surface of the through hole, the projection being configured to complimentarily, slidably dispose in the groove.

10. The bird feeder as claimed in claim 9, wherein the channel of the blocking roof extends from an outer surface of the blocking roof to terminate at the through hole, and the second positioning device is configured to urge against the groove of the containing structure.

11. A bird feeder comprising:
a containing structure including an internal space and at least one feeding opening on an outer surface of the containing structure and communicating with the internal space;
a perch with the containing structure disposed through and disposed under the feeding opening;
a blocking roof above the feeding opening and including a central through hole put on the containing structure and configured to slidably, longitudinally move on the containing structure, and a channel disposed through a surface of the through hole; and
at least one positioning device disposed through the channel to urge against the containing structure for fastening the blocking roof and the containing structure together.

12. The bird feeder as claimed in claim 11, wherein the containing structure further comprises at least one groove longitudinally formed on an outer surface thereof, and wherein the blocking roof further comprises at least one projection on an inner surface of the through hole, the projection being configured to complimentarily, slidably dispose in the groove.

13. The bird feeder as claimed in claim 12, wherein the channel of the blocking roof extends from an outer surface of the blocking roof to terminate at the through hole, and the positioning device is configured to urge against the groove of the containing structure.

14. The bird feeder as claimed in claim 11, wherein the positioning device includes an urging member and a spring member, and wherein the urging member is in an inner end of the channel and projects into the through hole, the spring member is in the channel and has one end urging against the urging member and the other end disposed at an outer end of the channel, and the spring member pushes the urging member to urge against the groove of the containing structure.

15. The bird feeder as claimed in claim 14, wherein the channel of the blocking roof is disposed from an outer surface of the blocking roof to the surface of the through hole, and the positioning device further comprises a plug in the channel and at the outer surface of the blocking roof, the plug being urged by the spring member.
